(19) United States
(12) Patent Application Publication
(10) Pub. No.: US 2020/0071965 A1
(43) Pub. Date: Mar. 5, 2020

(54) LOCKBOX INDEX DRIVE

(71) Applicant: Carrier Corporation, Jupiter, FL (US)

(72) Inventors: Joseph Zacchio, Wethersfield, CT (US); Lawrence Binek, Glastonbury, CT (US)

(21) Appl. No.: 16/490,370

(22) PCT Filed: Feb. 28, 2018
(86) PCT No.: PCT/US2018/020252

§ 371 Date: Aug. 30, 2019

Related U.S. Application Data
(60) Provisional application No. 62/465,428, filed on Mar. 1, 2017.

(51) Int. Cl. E05B 65/52; G07C 9/00; E05G 1/00

(52) U.S. Cl. CPC E05B 65/5269; E05G 1/005; G07C 9/00912

(57) ABSTRACT

A locking module for selectively coupling a first component and a second component of a lockable device includes an opening formed in the first component. A locking member is rotatable about an axis between an unlocked position and a locked position. The locking member includes a feature selectively receivable within the opening. An engagement mechanism is operable to rotate the locking member about the axis between the unlocked position and the locked position.

### BACKGROUND

This disclosure relates generally to a lockable device and, more particularly, to a locking module for use in a lockable device.

Lockboxes typically provide a secured storage area for a key or other access aid at a location close to a locked property accessible by the key. In this way, an authorized user can unlock the lockbox to gain access to the secured storage area and then use the key contained therein to unlock the locked property.

The lockbox is typically attached to a door handle or to another stationary object near the traditional lock. The lockbox typically requires the user to demonstrate that he is authorized to obtain access to the locked property before the secured storage area is unlocked to allow the user to obtain the key. In a mechanical lockbox, the user might be required to enter a correct lock combination to access the secured storage area. In an electronic lockbox, the user might be required to communicate a credential to lockbox (via a physical connection to the lockbox or via a wireless link to the lockbox) to access the secured storage area.

### SUMMARY

According to one embodiment, a locking module for selectively coupling a first component and a second component of a lockable device includes an opening formed in the first component. A locking member is rotatable about an axis between an unlocked position and a locked position. The locking member includes a feature selectively receivable within the opening. An engagement mechanism is operable to rotate the locking member about the axis between the unlocked position and the locked position.

In addition to one or more of the features described above, or as an alternative, in further embodiments said feature is receivable within said opening when said locking member is in said unlocked position.

In addition to one or more of the features described above, or as an alternative, in further embodiments said feature has a contour complementary to said opening when said locking member is in said unlocked position.

In addition to one or more of the features described above, or as an alternative, in further embodiments said feature is not receivable within said opening when said locking member is in said locked position.

In addition to one or more of the features described above, or as an alternative, in further embodiments said locking member is mounted within said second component.

In addition to one or more of the features described above, or as an alternative, in further embodiments said locking member includes an engagement feature configured to cooperate with said engagement mechanism to rotate said locking member about said axis.

In addition to one or more of the features described above, or as an alternative, in further embodiments said engagement feature includes a plurality of teeth.

In addition to one or more of the features described above, or as an alternative, in further embodiments a gear ratio of said engagement mechanism to said engagement feature is greater than 1:1.

In addition to one or more of the features described above, or as an alternative, in further embodiments said locking member is rotated 90 degrees about said axis between said unlocked positon and said locked position.

In addition to one or more of the features described above, or as an alternative, in further embodiments said mechanism is a mechanical mechanism that operates the locking member in response to a user input.

In addition to one or more of the features described above, or as an alternative, in further embodiments said engagement mechanism is an electromechanical mechanism that operates the locking member in response to a user input.

In addition to one or more of the features described above, or as an alternative, in further embodiments the locking module is applied to a lockbox such that first component is keybox and the second component is a body of the lockbox.

In addition to one or more of the features described above, or as an alternative, in further embodiments the locking module is applied to a lockbox such that first component is shackle and the second component is a body of the lockbox.

According to another embodiment, a method of operating a locking module of a lockable device includes operating a mechanism in response to a user input and rotating a locking member about an axis of rotation between a first position and a second position. The locking member includes a feature selectively receivable within an opening of a movable component of the lockable device.

In addition to one or more of the features described above, or as an alternative, in further embodiments said feature is receivable within said opening when said locking member is in said second position.

In addition to one or more of the features described above, or as an alternative, in further embodiments said feature has a contour complementary to said opening when said locking member is in said second position.

In addition to one or more of the features described above, or as an alternative, in further embodiments said feature is not receivable within said opening when said locking member is in said first position.

In addition to one or more of the features described above, or as an alternative, in further embodiments comprising rotating said locking member about said axis between said second position and said first position to selectively couple said movable component to the lockable device.

In addition to one or more of the features described above, or as an alternative, in further embodiments said locking member is configured to rotate about said axis between said first position and second position in a first direction and rotate about said axis between said second position and first position in a second direction, said first direction and said second direction being the same.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a perspective view of an example of a lockable device in a closed configuration;

FIG. 1B is a perspective view of an example of a lockable device having a keybox in an extended position; and

FIG. 2 is a perspective view of a locking module of the lockable device in a locked configuration according to an embodiment.

The detailed description explains embodiments of the present disclosure, together with advantages and features, by way of example with reference to the drawings.

### DETAILED DESCRIPTION

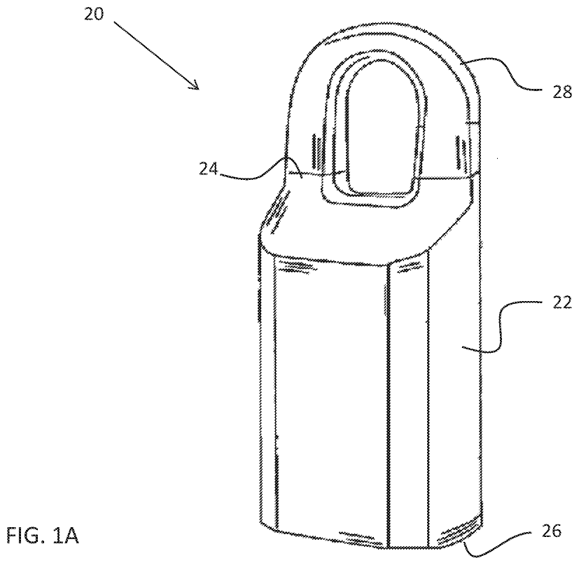

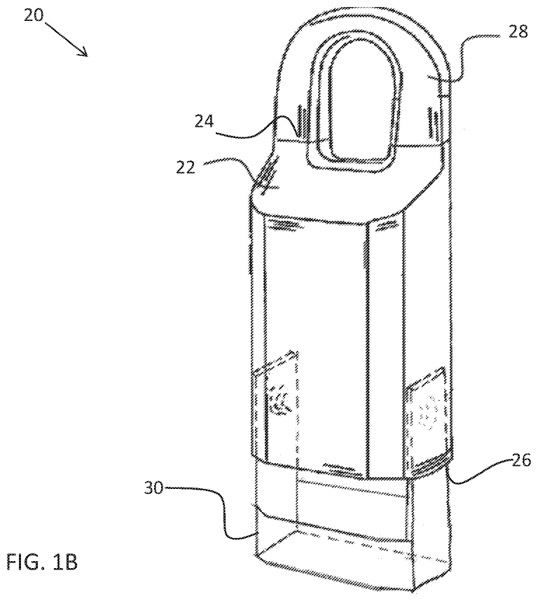

Referring now to FIGS. 1A and 1B, an example of a lockable device 20, such as a lockbox is illustrated. The lockbox 20 includes a body 22 and one or more components movable relative to the body 22. For example, the lockbox 20 additionally includes a shackle 28 positioned adjacent a first end 24 of the body 22 and a keybox 30 (best shown in FIG. 1B) positioned adjacent a second, opposite end 26 of the body 22. The shackle 28 may be configured to translate and/or rotate relative to the body 22. Alternatively, or in addition, the keybox 30 may be configured to translate relative to the body 22. In an embodiment, at least one of the shackle 28 and the keybox 30 is separable from the body 22.

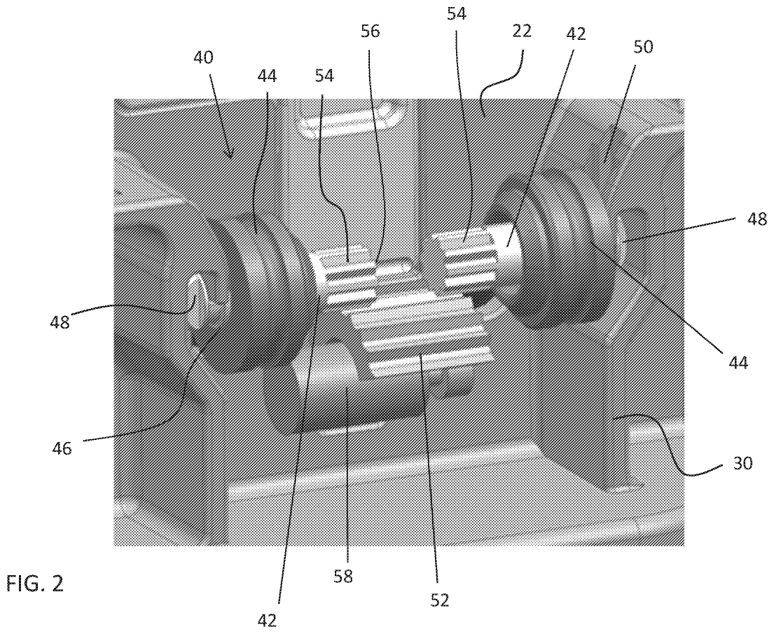

A locking module 40 (see FIG. 2) is operable to selectively couple a first component and a second component. In an embodiment, when applied to a lockable device, such as lockbox 20 for example, the locking module 40 selectively locks the shackle 28 to the body 22. Accordingly, the locking module 40 restricts movement of the lockbox 20 once arranged in a desired location via the shackle 28. Alternatively or in addition, the locking module 40 may be used to selectively lock the keybox 30 to the body 22. In such instances, operation of the locking module 40 may provide an authorized user with access to the internal cavity of the keybox 30, within which one or more items, such as a key for example, may be stored.

With reference now to FIG. 2, a locking module 40 configured to selectively couple the keybox 30 to the body 22 of a lockbox 20 is illustrated in more detail. As shown, the locking module 40 includes at least one locking member 42 rotatably supported, such as by a bearing 44 for example, within the interior of the body 22 of the lockbox 20. In the illustrated, non-limiting embodiment, the locking module includes two substantially identical locking members 42 configured to selectively engage opposing sides of the keybox 30. However, embodiments including only a single locking member 42 are also contemplated herein.

A first end 46 of the locking member 42 includes a shaped feature 48 operable to selectively restrict movement of the keybox 30 relative to the body 22. The shaped feature 48 is arranged generally adjacent a keyway 50 formed in the movable keybox 30. The contour of the shaped feature 48 is selected such that when the locking member 42, and therefore the shaped feature 48, is in a first locked position, the shaped feature 48 is not receivable within the keyway 50. However, when the locking member 42, and therefore the shaped feature 48, is in a second unlocked position, the shaped feature is receivable within the keyway 50 via a clearance fit, thereby allowing movement of the keybox 30 relative to the body 22. In the illustrated, non-limiting embodiment, the shaped feature 48 and the keyway 50 are generally T-shaped. However, it should be understood that a shaped feature 48 and keyway 50 having any configuration are also within the scope of the disclosure.

The locking module 40 additionally includes an engagement member 52 movable relative to the body 22. The engagement member 52 is configured to cooperate with or engage an engagement feature 54 formed at a second end 56 of the locking member 42 to transform the locking member 42 between the first locked position and the second unlocked position. In the illustrated non-limiting embodiment, the engagement member 52 includes a drive gear and the engagement feature 54 on the locking member 42 includes a plurality of gear teeth complementary to the gear teeth of the drive gear 52. However, it should be understood that any type of engagement member 52 configured to cooperate with the engagement feature 54 of the locking member 42 is contemplated herein. The gear ratio of the engagement member 52 to the locking member 42 may be greater than or less than 1:1 such that only a partial turn, such as a quarter turn of the drive gear 52 for example, is necessary to rotate the locking member 42 between the locked and unlocked positions.

The engagement member 52 is configured to move in response to operation of a mechanism, illustrated schematically at 58, operably coupled to the engagement member 52. Although the engagement member 52 is shown as being rotatable about an axis arranged substantially perpendicular to the keyway 50, other configurations of the engagement member 52 are also contemplated herein. The mechanism 58 for moving the engagement member 52 may be mechanically operated by a user, or alternatively, may include an electromechanical mechanism, such as a motor, solenoid, or a piezoelectric device for example, directly or indirectly coupled to the engagement member 52. In such embodiments, the mechanism 58 may be operable in response to an electrical input, such as generated by a code entered via a key pad or upon detection of an identification device, such as an RFID tag for example, having acceptable credentials.

In operation, a user provides an input to operate the mechanism 58 associated with the engagement member 52. In response to the input, the mechanism 58 drives rotation of the engagement member 52 about an axis. As a result of the interface between the engagement member 52 and the engagement feature 54 on the locking member 42, the locking member 42 is similarly driven about an axis, shown oriented parallel to the axis of the engagement member 52, such that the shaped feature 48 is rotated, for example 90 degrees, from a locked position to an unlocked position. In the unlocked position, the keybox 30 can translate relative to the locking module 40 and the body 22. To reconnect the keybox 30 to the body 22, the shaped feature 48 is aligned with and received within the keyway 50. The mechanism 58 is operated to either back drive or continue the rotation of the engagement member 52 until the locking member 42 reaches the locked position. Initiation of this operation of the mechanism 58 may occur once the keybox 30 is fully inserted, or alternatively, may occur in response to switch (not shown) activated as the keybox 30 is slidably inserted into the body 22.

The locking module 40 illustrated and described herein has a simplified configuration resulting in a reduced cost. Further, the compact design of the locking module 40 eliminates the required space within the keybox 30 and body 22. In addition, the locking module 40 is energy efficient by requiring limited movement to lock and unlock the module 40.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

1. A locking module for selectively coupling a first component and a second component of a lockable device comprising:
an opening formed in the first component;
a locking member rotatable about an axis between an unlocked position and a locked position, said locking member including a feature selectively receivable within said opening; and
an engagement mechanism operable to rotate said locking member about said axis between said unlocked position and said locked position.

2. The locking module of claim 1, wherein said feature is receivable within said opening when said locking member is in said unlocked position.

3. The locking module of claim 1, wherein said feature has a contour complementary to said opening when said locking member is in said unlocked position.

4. The locking module of claim 1, wherein said feature is not receivable within said opening when said locking member is in said locked position.

5. The locking module of claim 1, wherein said locking member is mounted within said second component.

6. The locking module of claim 1, wherein said locking member includes an engagement feature configured to cooperate with said engagement mechanism to rotate said locking member about said axis.

7. The locking module of claim 6, wherein said engagement feature includes a plurality of teeth.

8. The locking module of claim 5, wherein a gear ratio of said engagement mechanism to said engagement feature is greater than 1:1.

9. The locking module of claim 1, wherein said locking member is rotated 90 degrees about said axis between said unlocked positon and said locked position.

10. The locking module of claim 1, wherein said mechanism is a mechanical mechanism that operates the locking member in response to a user input.

11. The locking module of claim 1, wherein said engagement mechanism is an electromechanical mechanism that operates the locking member in response to a user input.

12. The locking module of claim 1, wherein the locking module is applied to a lockbox such that first component is keybox and the second component is a body of the lockbox.

13. The locking module of claim 1, wherein the locking module is applied to a lockbox such that first component is shackle and the second component is a body of the lockbox.

14. A method of operating a locking module of a lockable device comprising:
operating a mechanism in response to a user input; and
rotating a locking member about an axis of rotation between a first position and a second position, said locking member including a feature selectively receivable within an opening of a movable component of the lockable device.

15. The method of claim 14, wherein said feature is receivable within said opening when said locking member is in said second position.

16. The method of claim 14, wherein said feature has a contour complementary to said opening when said locking member is in said second position.

17. The method of claim 14, wherein said feature is not receivable within said opening when said locking member is in said first position.

18. The method of claim 14, further comprising rotating said locking member about said axis between said second position and said first position to selectively couple said movable component to the lockable device.

19. The method of claim 18, wherein said locking member is configured to rotate about said axis between said first position and second position in a first direction and rotate about said axis between said second position and first position in a second direction, said first direction and said second direction being the same.
